(19) United States
(12) Patent Application Publication
(10) Pub. No.: US 2006/0098537 A1
(43) Pub. Date: May 11, 2006

(54) All kinds of printing materials be recorded in all kinds of recordable materials for sale

(76) Inventor: Henri Duong, Rosemead, CA (US)

Correspondence Address: Henri Duong, 316 1/2 E Glendon way, Alhambra, CA, 91801, US

(21) Appl. No.: 10/867,330

(22) Filed: Jun. 15, 2004

(51) Int. Cl. G11B 7/085

(52) U.S. Cl. 369/30.1

(57) ABSTRACT

All kinds of printing materials; books, indexes, dictionaries, telephone directories, catalogs, magazines, newspapers etc are recorded in all kinds of recording materials; discs, magnetic/non magnetic disks, CDs, DVDs, CD-ROM, compact disks, (formatted) disks, cassettes, tapes, cards, all forms of recordable sheets or films etc for sale will reduce traditional publication business to a minimum cost thus modernizing publication industry to a new stage.

### CROSS-REFERENCE TO RELATED APPLICATIONS

Disclosure Document Deposit Request; former Disclosure Document No: 503814 date Jan. 18, 2002 and 545573 date Jan. 26, 2004 PTO-1652 (August 1999)

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

Millions of mankind have lost their lives killed by a variety of weapons in war history around the world. There are certainly no arms using without killing effect, disarmament remains as a means of arms control but it does not lessen power of weapons. It made me thinking about using “Anesthetic” as weapons to save human lives during military mission. recordable sheets or films etc for sale, it will cost less than publication in paper sheets, my original idea is created to have my written manuscript recorded in CD (disc) by myself.

### BRIEF SUMMARY OF THE INVENTION

Advantages of the discovery are to:
lower publication and transportation costs at the minimum
benefit readers and educational programs financially and wisely
save time of reading by listening (CD) discs. repeat voice
make pictures moving in issues
print directly (CD) disc material one time from computer
record (CD) disc two sides to store more materials

The invention composes of recording process, all kinds of printing materials with their written contents; books, indexes, dictionaries, telephone directories, catalogs, magazines, newspapers, all kinds of recording materials; discs, magnetic/non magnetic disks, CDs, DVDs, (formatted) disks, compact disks, diskettes, (CD-ROM) disks, cassettes, tapes, cards, all forms of recordable sheets or films etc., all kinds of (sound) recorders; computers with PCs etc., any other screen/display readable instruments with sound and necessary procedure, e-mail. web page. fax. telex. any other electronic transmission: computers. laptops. “Internet connection”. e-mail sending apparatus etc. clients,

### BRIEF DESCRIPTION OF THE SEVERAL VIEWS OF THE DRAWING

FIG. 1; Network of recording process

FIG. 2 ; Cost of disc & recording process

### DETAILED DESCRIPTION OF THE INVENTION

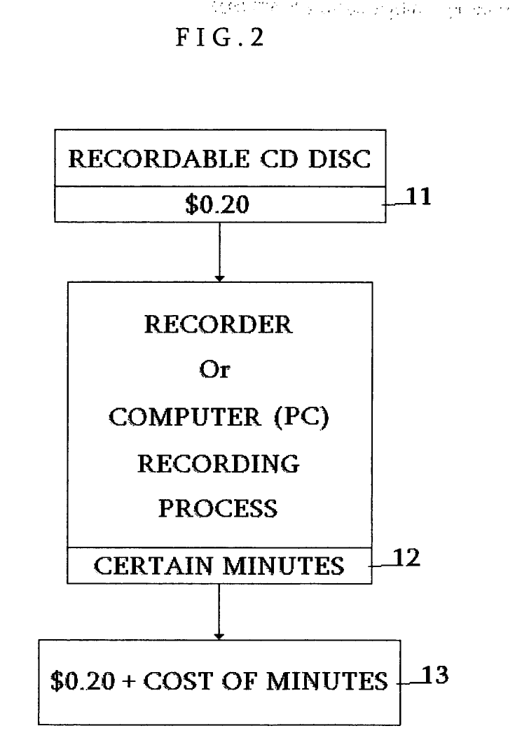

FIG. 2 ; A few cents 11 for a (CD) disc and certain minutes 12 for recording process cost a recorded disc at minimum rate 13 that high charges of today's publishing process will diminish least to a new stage.

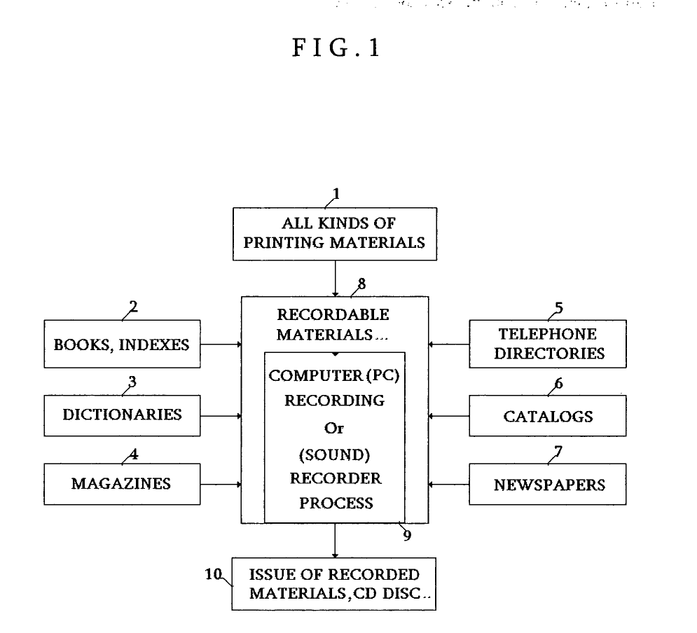

FIG. 1; All kinds of printing materials 1; indexes, books 2, dictionaries 3, magazines 4, telephone directories 5, catalogs 6, newspapers 7 etc are recorded in all kinds of recording materials 8; discs, magnetic/non magnetic disks, compact disks, CD (discs), (formatted) disks, diskettes, (CD-ROM) disks, cassettes, tapes, cards, all forms of recordable sheets or films etc for sale, recording process will be recorded with all kinds of recorders; computers with PCs 9 etc and readers will display recorded materials 10 to read on computers or any other screen display sets as they read on books.

All kinds of printing materials; books, indexes, dictionaries, telephone directories, catalogs, magazines, newspapers etc will be sound recorded in all kinds of recording materials; discs, magnetic/non magnetic disks, (CD) disc, compact disks, (formatted) disks, diskettes, (CD-ROM) disks, cassettes, tapes, cards, all forms of recordable sheets or films etc by all kinds of (sound) recorders. Readers may use computers with PCs or any other screen/display readable instruments with sound listening instead of reading contents of material by themselves. (CD) disc will be manufactured in both sides recording rather than one side recording.

1-3. (canceled)

4. What I claim as my invention is: All kinds of printing materials with their written contents are recorded in all kinds of recordable materials for sale including:
printing materials; books, dictionaries, telephone directories, catalogs, magazines, newspapers, indexes, of all sorts.
All kinds of printing materials with their written contents recording in all kinds of recordable materials for sale referring to claim 4, wherein recording in discs of all sorts replaces printing in papers of said materials:
All kinds of printing materials with their written contents recording in all kinds of recordable materials for sale referring to claim 4, wherein printing materials are recorded in discs of all sorts with/without voice, music, moving pictures, etc.
All kinds of printing materials with their written contents recording in all kinds of recordable materials for sale referring to claim 4, wherein printing materials include manuscripts, books, dictionaries, telephone directories, catalogs, magazines, newspapers, indexes, etc.
All kinds of printing materials with their written contents recording in all kinds of recordable materials for sale referring to claim 4, wherein indexes include telephone numbers, fax numbers, telex numbers, web site pages, P.O. Box numbers, e-mail addresses and addresses of residents, those of business companies; manufacturers, enterprises, companies, agencies, organizations, associations, etc.
All kinds of printing materials with their written contents recording in all kinds of recordable materials for sale referring to claim 4, wherein contents include written/recorded contents of manuscripts, of books, of dictionaries, of telephone directories, of catalogs, of magazines, of newspapers, of indexes, etc.
All kinds of printing materials with their written contents recording in all kinds of recordable materials for sale referring to claim 4, wherein contents of printing materials are recorded in discs, magnetic/non magnetic disks, CDs, DVDs, (formatted) disks, diskettes, compact disks, CD-ROM, disks, cassettes, tapes, cards, etc and all forms of recording sheets or films with/without cover boxes for sale.
All kinds of printing materials with their written contents recording in all kinds of recordable materials for sale referring to claim 4, wherein discs of all sorts have contents of computer software programs using for books, dictionaries, telephone directories, catalogs, magazines, newspapers, etc and their contents.
All kinds of printing materials with their written contents recording in all kinds of recordable materials for sale referring to claim 4, wherein discs of all sorts have contents of computer software programs using for indexes and their contents.
All kinds of printing materials with their written contents recording in all kinds of recordable materials for sale referring to claim 4, wherein naming includes naming instruction guides, children picture stories, children mathematics, US documentation, data as titles on discs of all sorts having their contents of said printing materials.
All kinds of printing materials with their written contents recording in all kinds of recordable materials for sale referring to claim 4, wherein naming includes naming programs of testing, of teaching, of accounting, of computer software, of restoration computer CD, of installation software as titles on discs of all sorts having their contents of said printing materials.
All kinds of printing materials with their written contents recording in all kinds of recordable materials for sale referring to claim 4, wherein naming includes naming music, moving pictures, movies, albums, and other names as titles on discs of all sorts having their contents of said printing materials.
All kinds of printing materials with their written contents recording in all kinds of recordable materials for sale referring to claim 4, wherein recording includes “create”, “write ”, “edit”, “type”, “design”, “record”, “tranfer”, “copy”, “make”, “do”, “print” and “process” etc manuscripts, contents of traditional publication in said materials to discs, recording objects of all sorts for sale.
All kinds of printing materials with their written contents recording in all kinds of recordable materials for sale referring to claim 4, wherein recording and displaying include using recorders and displayers of all kinds; recorders, sound recorders, computers with PCs, laptops, (screen) display readable instruments with/without sound, any other similar equivalents, necessary procedure.
All kinds of printing materials with their written contents recording in all kinds of recordable materials for sale referring to claim 4, wherein recordable materials include recordable objects of all kinds; discs, magnetic/non magnetic disks, CDs, DVDs, (formatted) disks, diskettes, compact disks, CD-ROM, disks, cassettes, tapes, cards, recording sheets or films of all forms with/without cover boxes, etc.
All kinds of printing materials with their written contents recording in all kinds of recordable materials for sale referring to claim 4, wherein electronic transmission for discs; transmitting contents of books, of dictionaries, of telephone directories, of catalogs, of magazines, of newspapers, of indexes, etc by e-mail, web pages, fax machine, telex, using computers, laptops, e-mail sending apparatus, electronic “Internet” connection, etc to clients for sale.
All kinds of printing materials with their written contents are recorded in all kinds of recordable materials for sale referring to claim 4, wherein excluding discs with contents of documentation, of data sold by US government.
All kinds of printing materials with their written contents are recorded in all kinds of recordable materials for sale referring to claim 4, wherein excluding discs with contents of instruction guides, of children picture stories and of children mathematics with/without voice, music, moving pictures.
All kinds of printing materials with their written contents are recorded in all kinds of recordable materials for sale referring to claim 4, wherein excluding recordable materials of music, of moving pictures and of movies.
All kinds of printing materials with their written contents are recorded in all kinds of recordable materials for sale referring to claim 4, wherein excluding discs with contents of testing programs, of instructional programs, of accounting programs, of computer software programs, of restoration computer CD, of installation software for computers, laptops, printers and electronic instruments.
All kinds of printing materials with their written contents recording in all kinds of recordable materials for sale referring to claim 4, wherein both sides recording; recordable materials or equivalents; CD, DVD, CD-ROM discs, compact disks, cards, all forms of recording sheets with/without cover (boxes) are manufactured in both sides recording rather than one side recording.

5. What I claim as my invention is: The elements, structures, composition, recording, contents in claim 4, claim 5 and claim 6, illustrations, process of making the invention in these documents, and/or any other structures, modifications, formation to the same effect, using the invention everywhere.

6. What I claim as my invention is: Combining the invention in claim 4, claim 5 and claim 6 with any other products, equipments/instruments of all kinds; hard drive (disk), printers, photo printers, scanners, copiers, fax machines, telephones, televisions, monitors, computers PCs, laptops, word processors, CD recorders, DVD recorders, cassette recorders, CD/DVD players, video recorders, graphic players, fans, game-boys, compact music systems, sending e-mail apparatus, photo processing machines, video cassettes, radios, radio cassettes, cameras, camcorders, (video) projectors, watches/clocks etc, all kinds of printing issues, books, etc for sale are in the scope of protection of the invention.
